(19) United States
(12) Patent Application Publication
(10) Pub. No.: US 2011/0023615 A1
(43) Pub. Date: Feb. 3, 2011

(54) Rock Drill Testing Apparatus and Method

(76) Inventor: John Piche, Manitouwadg (CA)

Correspondence Address: ADE & COMPANY INC., 2157 Henderson Highway, WINNIPEG, MB, R2G1P9, CA

(21) Appl. No.: 12/512,464

(22) Filed: Jul. 30, 2009

(51) Int. Cl. G01L 7/00

(52) U.S. Cl. 73/700

(57) ABSTRACT

An apparatus for testing a rock drill has a base structure, a displaceable structure movable toward and away from the base and a fluid pumping mechanism carried on one of the structures to be driven by the rotation of the rock drill. The air leg of the rock drill is deemed either operational or in need of repair based on whether attempted extension of the leg is sufficient move the displaceable structure away from the base. A control mechanism in a fluid passage fed by the pump output is closable so that a pressure builds up in the passage under operation of the pump. Successful of unsuccessful buildup of the pressure to a sufficient level reflecting good rotational operation of the drill reflects whether the drill component is to be deemed operational or in need of repair. Quick and simple testing of both the leg and drill components is facilitated.

### FIELD OF THE INVENTION

The present invention relates generally to equipment and methods for testing of rock drills before each deployment for use to determine whether they are in good functional condition or in need of service or repair.

### BACKGROUND OF THE INVENTION

Stoper and jack-leg drills are two types of rock drills commonly used in mining operations. These pieces of equipment are deployed to different areas of a mine site as their use is required. As with all equipment, it is desirable to minimize down time in which the rock drill is not available for use. In mining, a particular rock drill will sometimes be deployed from an area at which it is normally stored to a particular location in the mine or use by an operator, only for the operator to discover that the rock drill is not functioning properly. Time is wasted as the defective unit must be transported back out of the mine for repair and a replacement rock drill is deployed in its place.

Accordingly there is a desire for rock drill testing equipment and methods that facilitate testing of rock drills before their deployment into a mine in order to first establish that the equipment is in good working order, and not in urgent need of service or repair.

### SUMMARY OF THE INVENTION

According to a first aspect of the invention there is provided a rock drill testing apparatus comprising:

a base structure;

a displaceable structure spaced from the base structure and movable toward and away from the base structure along a linear axis;

a fluid pumping mechanism mounted to a respective one of the base and displaceable structures, the fluid pumping mechanism thereof being operable by driven rotation of an input shaft thereof extending parallel to the linear axis, the input shaft being rotatable about the linear axis relative to the base and displaceable structures and being engagable by a drill component of a rock drill at an end of the input shaft nearest an opposite one of the base and displacement structures;

a fluid passage communicating with an outlet of the pumping mechanism;

a flow control mechanism operably installed on the fluid passage at a distance therealong from the outlet of the fluid pumping mechanism to close and then open the fluid passage with the fluid pumping mechanism running to first cause a buildup of pressure in the fluid passage when closed and then relieve the buildup of pressure in the fluid passage when opened; and

an indicator mechanism associated with the fluid passage and operable to provide an indication of a status of the buildup of pressure in the flow passage under operation of the fluid pumping mechanism with the fluid passage closed.

Preferably the fluid pumping mechanism comprises a hydraulic pump and the fluid passage is also communicating with an inlet of the fluid pumping mechanism.

Preferably the fluid passage comprises a fluid conduit that communicates with the inlet and outlet of the fluid pumping mechanism and a hydraulic fluid reservoir connected inline with the fluid conduit at a position therealong between the flow control mechanism and the inlet of the fluid pumping mechanism.

Preferably the hydraulic fluid reservoir is mounted on the respective one of the base and displaceable structures on which the hydraulic pump is mounted.

Preferably the flow control mechanism comprises a pressure relief valve installed on the fluid passage to open the fluid passage only after the pressure buildup therein exceeds a given level.

Preferably there are provided displacement resisting devices associated with the displaceable structure to resist movement thereof away from the base structure. Preferably the displacement resisting devices are configurable to allow adjustment of resistance to movement of the displaceable structure away from the base structure.

Preferably the displaceable structure disposed over the base structure and is movable upward and downward away from and toward the base structure.

Preferably the displacement resisting devices comprises weights carried with the displaceable structure and suspended at a position downward therefrom. Preferably the weights are selectively disconnectable from the displaceable structure to facilitate swapping of different weights for one another on the apparatus.

Preferably the weights have guide features thereon cooperable with stationary guide members projecting away from the base structure toward the displaceable structure to guide motion of the weights along the guide members during lifting and lowering of the displaceable structure away from and toward the base structure.

Preferably the guide features comprise collars fixed to the weights and closing around the guide members

Preferably there are provided stops defined on the guide members for engagement thereagainst by the guide features on the weights under lifting of the displaceable structure away from the base structure by a given distance to prevent movement of the guide features passed upper ends of the guide members.

Preferably the weights comprise metal plates.

Preferably the guide members comprise outer tubular members fixed to the base structure and projecting upward therefrom parallel to the linear axis and inner members fixed to and projecting downward from the displaceable structure are slidably received in the guide members to limit movement of the displaceable structure to movement along the linear axis.

Preferably the indicator mechanism comprises a pressure gauge operably installed on the fluid passage between the outlet of the fluid pumping mechanism and the flow control mechanism.

Preferably the fluid pumping mechanism is carried on the displaceable structure on a side thereof opposite the base structure and the input shaft projects through the displaceable structure.

Preferably movement of the displaceable structure is guided by a pair of parallel telescopic supports projecting from the base structure to the movable structure, the telescopic supports comprising stationary sections fixed to the base structure adjacent opposite sides thereof and movable sections slidable relative to the stationary sections toward and away from the base structure, and the displaceable structure comprising a cross member fixed to and extending between the movable sections of the parallel telescopic supports for movement with the movable sections toward and away from the base structure.

Preferably the stationary sections of the telescopic supports comprise tubular members in which the movable sections of the telescopic supports are slidably disposed.

Preferably the pumping mechanism is mounted to the displaceable structure.

According to a second aspect of the invention there is provided a rock drill testing apparatus comprising:

a base structure;

a displaceable structure positioned over the base structure at a distance upward therefrom and lowerable and liftable toward and away from the base structure along a linear axis;

a rotatable element mounted to a respective one of the base and displaceable structures and extending parallel to the linear axis, the rotatable element being rotatable about the linear axis relative to the base and displaceable structures against a source of rotation resistance and being engagable by a drill component of a rock drill at an end of the rotatable element nearest an opposite one of the base and displacement structures; and

weights carried with the displaceable structure and suspended at positions downward therefrom to resist lifting of the displaceable structure away from the base structure.

According to a third aspect of the invention there is provided a rock drill testing method comprising:

positioning a rock drill between a base surface and a displaceable load movable toward and away from the base surface;

with the rock drill remaining between the base surface and the displaceable load, performing a leg test and a drill test, the leg test comprising attempting to extend a telescopic leg component of the rock drill against the load to move the load away from the base surface and the drill test comprising using a drill component of the rock drill as a drive source for a fluid pumping mechanism to attempt to pump fluid into a closed fluid passage and buildup a pressure level therein; and

deeming the rock drill either (a) suitable for use if the rock drill passes both the leg test and the drill test by successfully moving the load away from the base surface in the leg test and successfully building up the pressure level in the drill test, or (b) unsuitable for use if the rock drill fails one or both of the leg test and the drill test.

### BRIEF DESCRIPTION OF THE DRAWINGS

In the accompanying drawings, which illustrate an exemplary embodiment of the present invention:

FIG. 1 is a front elevational view of a rock drill test apparatus according to the present invention.

FIG. 2 is a side elevational view of the rock drill test apparatus.

FIG. 3 is a front elevational view of a hanger bracket of the rock drill test apparatus.

FIG. 4 is a side elevational view of a weight of the rock drill test apparatus.

FIGS. 5A and 5B are overhead plan and front elevational view of a hydraulic pump mounting bracket of the rock drill test apparatus.

FIGS. 6A and 6B are overhead plan and front elevational views of a hydraulic pump mounting spacer of the rock drill test apparatus.

FIG. 7 is a front elevational view of a hydraulic reservoir mounting bracket of the rock drill test apparatus.

FIG. 8 is a side elevational view of a pressure relief valve mounting bracket of the rock drill test apparatus.

FIGS. 9A and 9B are side elevational and overhead plan views of a weight guiding bracket of the rock drill test apparatus

### DETAILED DESCRIPTION

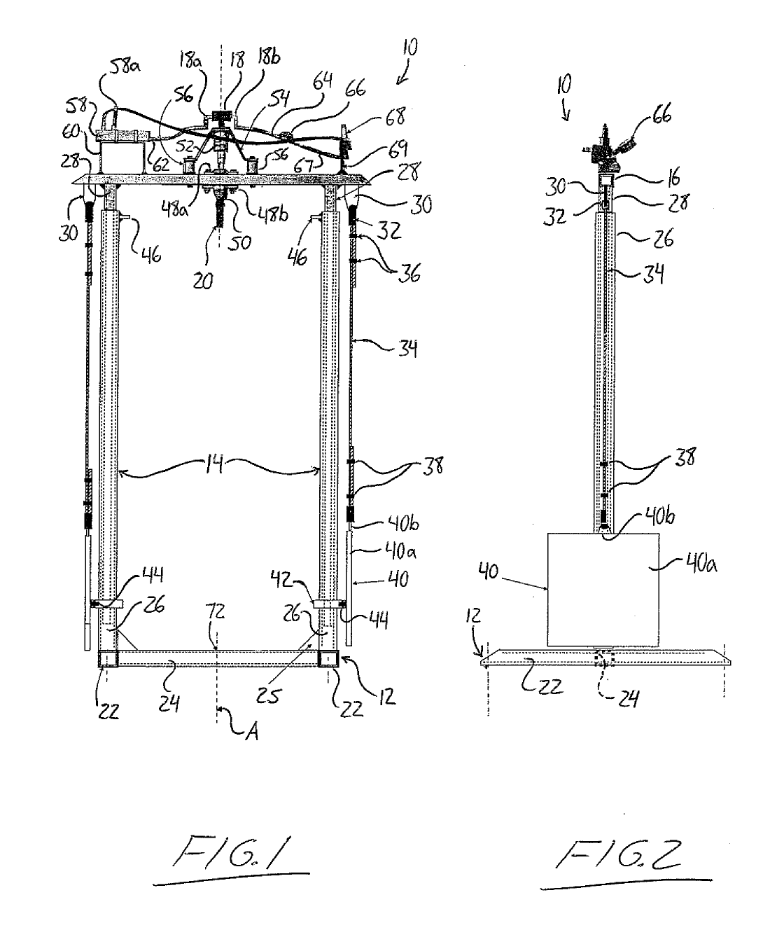

FIGS. 1 and 2 show an apparatus 10 for testing both the pneumatically expanding and contracting leg component and pneumatically rotating drill component of a rock drill, whether a stopper drill or jack-leg drill. The testing apparatus 10 of the illustrated embodiment is configured as an upright stand having a horizontally oriented base frame 12, a pair of parallel telescopic support leg assemblies 14 projecting vertically upward from the base at opposite sides thereof and a horizontally oriented cross member 16 extending between the support leg assemblies 14 at the movable upper ends thereof opposite the base frame 12. A hydraulic pump 18 is mounted atop the cross member 16 and has its internal drive shaft coupled with a rod 20 that projects vertically downward through the cross member 16 at a central position between the support leg assemblies 14 to form an extension of the pump drive shaft so that the rod and driveshaft are rotatable together and collectively form an input shaft assembly that is rotatable to drive the pump. For testing of a rock drill, the bottom base end of the rock drill's air leg is placed atop the base frame 12 of the test apparatus 10, or the ground therebeneath, and the chuck of the rock drill's drilling end is locked onto the rod 20. Expansion of the air leg with the rock drill in this vertically position in the test stand acts to lift the weight of the cross member 16 and the components carried therewith to verify the functionality of the air leg, and driving of the drill component of the rock drill drives the hydraulic pump to build up a pressure in a hydraulic conduit connected to the pump to confirm the rotational functionality of the rock drill.

### Structure

The structure of the illustrated testing apparatus 10 is described in further detail as follows.

The base frame 12 features a pair of feet 22 each disposed immediately beneath a respective one of the telescopic leg assemblies 14 and each formed by a length of rectangular steel tubing extending horizontally in a direction normal to the vertical plane at which the two parallel support legs 14 lie. A central member 24 of the base frame 12 extends horizontally between the two feet 22 at the plane of the support legs 14, closing off a planar rectangular area bound between the two support legs 14 the cross member 16 and the central frame member 24. Each support leg assembly 14 features a stationary section 26 defined by another length of rectangular steel tubing fixed at its lower end to the respective foot 22 at a central position therealong to project vertically upward from the horizontal base frame 12. The upper end of the stationary tube 26 is left open and a respective cross-sectionally smaller piece of steel rectangular tubing fixed at its upper end to the cross member depends downward into the stationary tube 26 through the open upper end thereof to define a movable section 28 of the respective leg assembly 14 slidably disposed within the stationary section to give the leg assembly a telescopic configuration. Triangular vertically oriented gusset plates 55 are fixed between the central frame member 24 and the stationary sections 26 to better support the leg assemblies 14.

The telescopically assembled linear sections 26, 28 of the leg assemblies 14 allow the cross member 16 to move relative to the base frame 12, but substantially limit this motion of the cross member 16 to vertical displacement along a linear vertical axis A normal to the horizontal plane of the base frame 12. The displaceable cross bar 16 of the illustrated embodiment is defined by a piece of rectangular steel tubing of the same dimension as that of the movable inner sections 28 of the leg assemblies 14, this cross bar being fixed to and crossing the upper ends of the inner leg sections 28 so as to extend laterally outward past the two leg assemblies on opposite sides of the base frame 12. At these shoulder-like end portions 16a of the cross member 16 projecting outward past the respective leg assemblies 14, hanger brackets 30 are fixed to and project a short distance downward from the bottom surface of the cross member 16. In the illustrated embodiment, each of the two hanger brackets is defined by a small metal plate 30a fixed to the cross member 16 at an upper end, for example by welding, and having a single round hole 30b passing normally therethrough near a bottom end of plate furthest from the cross member 16, as shown in FIG. 3. A shackle 32 passes through the hole of each hanger bracket 30 and a vertically hanging steel cable 34 passes through the opening of the shackle 32 and then folds back over itself to define an upper end of the cable connected to the shackle and hanger bracket, the cable being secured to itself by cable clamps 36 to define this looped upper end. A likewise looped bottom end of the cable formed by another portion of the cable where it is folded back over itself and secured by additional cable clamps 38 carries a weight 40. As shown in FIG. 4, the weight of the illustrated embodiment is provided by a generally rectangular steel plate 40a having an integral lug 40b projecting vertically upward from a top horizontal edge of the otherwise rectangular weight. A round hole 40c passing normally through the flat lug 40b has another shackle 44 passed through it, which in turn has the looped bottom end of the cable 34 passed through it to form the connection between the cable and the weight 40.

Each weight 40 is provided with a guide bracket 42 projecting from the inwardly directed face of the weight facing toward the weight on the opposite side of the stand. The guide bracket 42 cooperates with the plate structure of the weight to define a rectangular collar that closes about the stationary lower section 26 of the respective leg assembly adjacent the weight 40. With reference to FIG. 9, the guide bracket 42 of the illustrated embodiment is a flat bar having been bent at right angles at four points along its width to take on a winged U-shape with straight flat sections and right angle corners. The resulting guide bracket 42 has two spaced-apart coplanar foot sections 42a at opposite ends, two parallel leg sections 42b projecting at right angles from the adjacent inner ends of the foot sections 42a and a central section 42c parallel to the foot sections to perpendicularly interconnect the leg sections 42b at ends thereof opposite the foot sections. The central and leg sections 42b, 42c define a squared-off U-shape, and the foot sections define wings of this U. Each foot section 42a has a round through hole 42d passing normally therethrough to receive a respective one of two threaded studs 40d projecting normally from the inwardly directed face of the respective weight 40 at symmetrical positions horizontally across a central vertical axis 40e of the weight's plate structure. The U-shape of the guide bracket 42 has its feet 42a placed against the inner face of the weight from the side of the respective leg assembly 14 opposite the weight to slide the holes 42d of the guide bracket 42 over the studs 40d of the weight for tightening of nuts 44 onto the studs from the side of the feet 42a opposite the face of the weight to fasten the guide bracket onto the weight. As a result, the stationary lower section 26 of the telescopic support leg assembly 14 is disposed within a rectangular area bound by the three sides of U-shaped portion of the guide bracket 42 and the inner face of the weight.

Referring to FIG. 1, lifting of the cross member 16 away from the base frame 12 acts to also lift the inner sections 28 of the telescopic support legs 14 and the weights suspended from the cross member by the hanger brackets 30 and cables 34. The guide brackets 42 on the weights 40 slide along the stationary lower sections 26 of the support leg assemblies 14 to guide the weights during this lifting and subsequent lowering so that the weights follow linear paths parallel to those of the displacement of the cross member 16 and inner movable sections 28 of the support legs 14. The stationary lower sections 26 of the telescopic leg assemblies 14 thus not only define guides to establish the linear motion path of the cross member and attached inner leg sections 28, but also define guides to establish parallel paths of motion for the weights. A small rectangular plate 46 fixed to the stationary lower section 26 of each telescopic leg assembly 14 projects horizontally inward therefrom a short distance toward the opposite leg assembly to form a stop that limits upward sliding of the guide brackets 42 on the weights to prevent sliding of the guide brackets 42, and the bottom ends of the movable inner sections 28 disposed at an elevation below the guide brackets 42, from sliding upwardly past the stops and off the top ends of the stationary lower sections 26 of the leg assemblies 14.

At a central position along the cross member 16, a vertical hole passes therethrough along the central axis A between the support leg assemblies 14. Two flanged roller bearings 48a, 48b are mounted on the cross member, one on the upward facing side thereof to define an upper roller bearing 48a and one of the downward facing side of the cross member to define a lower roller bearing 48b. The central opening through each of these two roller bearings 48, 48b is concentrically aligned with the vertical hole through the cross member 16. In the illustrated embodiment, the two roller bearings are the same and have their flanges bolted to the cross member 16 by bolts passing through the flanges of both bearings and the cross member therebetween. A thrust bearing 50 is mounted to the lower roller bearing 48b at a position immediately therebeaneath. The rod 20 is made of drill steel and passes vertically upward form its bottom end through the thrust bearing 50, lower roller bearing 48b, cross member 16 and upper roller bearing 48a. At its top end, the rod 20 is fixed to a mechanical coupling 52 that couples the rod 20 to the drive shaft of the hydraulic pump 18.

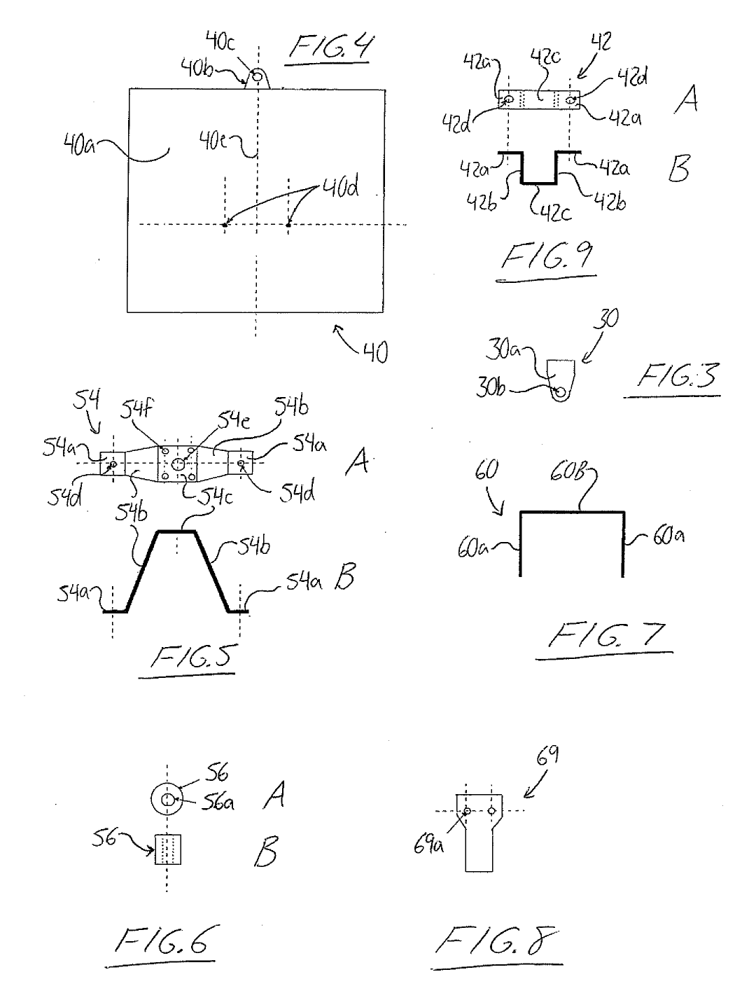

A pump mounting bracket 54 installed on the cross member 16 supports the hydraulic pump 18 at a distance above the cross member 16. The pump mounting bracket of the illustrated embodiment, shown in isolation in FIG. 5, is formed by a flat steel bar bent into a shape somewhat similar to that of the guide brackets 42, but on a larger scale. The installed pump mounting bracket 54 features two coplanar horizontal feet 54a disposed on opposite sides of the rotational rod and bearing assembly at the center of the cross member 16, a pair of legs 54b projecting convergingly upward from adjacent inner ends of the feet 54a nearest the rod 20 and a central section 54c horizontally interconnecting the top ends of the converging legs 54b at a position over the connection of the mechanical coupling 52 to the rod 20. A pair of round steel cylindrical spacers 56, one of which is shown in isolation in FIG. 6, each feature a bore 56a passing vertically therethrough along the longitudinal axis of the spacer's cylindrical shape. Each spacer is disposed between the top surface of the cross member 16 and the bottom surface of a respective foot 54a of the pump mounting bracket 54. A bolt passes vertically through the cross member 16, the bore 56a of the spacer 56 and a through hole 54d in the respective foot 54a of the pump mounting bracket and is fitted with a mating nut to clamp these elements together and secure the pump mounting bracket 54 in place atop the cross member 16. The drive shaft of the pump 18, or part of the mechanical coupling 52 fixed thereto, passes vertically through a central through hole 54e in the central section 54c in the pump mounting bracket. Four mounting holes 54f near the four corners of the central section 54c of the pump mounting bracket 54 are provided to receive fasteners to facilitate mounting of the housing of the pump 18 to the top surface of the pump mounting bracket's central section 54c.

A reservoir 58 containing hydraulic fluid is also mounted atop the cross member 16 using a bracket. The reservoir mounting bracket 60 of the illustrated embodiment, shown in isolation in FIG. 7, is a flat steel bar bent into three linearly extending sections disposed at right angles to one another to create two legs 60a fixed to the cross member, for example by welding, to project vertically upward from the top surface of thereof and a central section 60b extending horizontally between the upper ends of these legs. The hydraulic fluid reservoir 58 is fixed atop the central section 60b of the reservoir mounting bracket 60 and includes an oil filler tube 58a projecting vertically upward from within the reservoir. A first section of flexible tubing 62 is connected to the reservoir at one end in sealed fluid communication with the reservoir's interior through a port in a wall of the reservoir and is coupled to the pump 18 at the opposite end in sealed fluid communication with an inlet 18a of the hydraulic pump 18. A second section of flexible tubing 64 is connected in sealed fluid communication with an outlet 18b of the hydraulic pump at one end and with in an inlet side of a pressure gauge 66 at an opposite end. A third section of tubing 67 is connected in sealed fluid communication with an outlet of the pressure gauge 66 at one end and with in an inlet side of a pressure relief valve 68 at an opposite end. A final fourth section of tubing 70 is connected in sealed fluid communication with an outlet of the pressure relief valve 68 at one end and with an inlet port of the reservoir 58 at the opposite end. The tubing sections thus define a fluid flow passage that connects the inlet and outlet of the pump and by way of a conduit having an inline installation thereon of a pressure gauge, pressure relief valve and fluid reservoir, in this order, from the pump outlet to the pump inlet. In the illustrated embodiment, the reservoir and pressure relief valve are carried adjacent opposite ends of the cross member 16 on opposite sides of the centrally mounted pump, and the pressure relief valve 68 is mounted on top of the cross member using a valve supporting bracket 69, shown in isolation in FIG. 8, formed by a vertically projecting plate having fastener holes 69a and being fixed to the top surface of the cross member 16, for example by welding.

Although not readily visible in the drawings, the test stand apparatus may have rubber pads of ¼-inch thickness placed between each foot of the pump mounting bracket and the respective spacer, between each spacer and the cross member and between the pump housing and the central section of the pump mounting bracket to provide vibratory isolation between the pump and the cross member during operation of the pump.

### Operation

The use of the illustrated testing apparatus 10 is described in further detail as follows.

The air leg of a stoper or jack-leg type rock drill is stood vertically between the parallel support leg assemblies 14 of to engage the base end of the air leg with the central frame member 24 or the ground on which the base frame 12 is disposed. For example, a stoper drill with a pointed tip of its air leg's piston rod may engage the central frame member 24 by inserting the pointed tip into a vertical hole passing through the central frame member's 24, or at least through the horizontal top wall of the tubular structure of the illustrated central frame member 24, at the central vertical axis A of the test stand apparatus, as generally indicated at 72 in FIG. 1. The claw-like foot of a jack-leg drill may instead be placed over the central frame member 24 to instead seat upon the ground on opposite sides thereof. The frame assembly or the ground on which it is disposed to support the test stand apparatus thus forms a stationary horizontal base structure against which air leg may push when telescopically expanded under pneumatic actuation.

The stand is built sufficiently tall so that the cross member 16 is high enough to accommodate the length of the rock drills to be tested between the base structure and the bottom end of the rod 20 when the cross member is in its lowest position, which may correspond to the movable sections 28 of the support legs 14 sitting atop the feet 22 of the base frame 12, the cross member 16 sitting atop the top ends of the stationary sections 26 of the support legs 14, or engagement of some other stop-defining configuration denoting the fully retracted position in which the cross member is nearest the base structure. The drill chuck of the rock drill is opened, the air-leg is telescoped to expand a short distance to position the rod 20 within the drill chuck, and the chuck is subsequently closed around the rod 20 of the test stand for gripping thereof in the same manner as it would engage a rock drill bit when prepared for use of the drill at a mining site. With the air leg and drill component of the rock drill coupled to a suitable source of compressed air in its normal manner, the rock drill is now considered installed in the test stand apparatus and ready for testing.

The stand enables testing of both the air leg and the drill component of the rock drill simultaneously, or separately but without requiring any removal of the rock drill or reconfiguration of any aspect of the rock drill's installation within the test stand.

In a leg test or lift test, the air leg control is used to introduce compressed air to force the expansion of the air leg and accordingly displace the drill component at the top of the air leg upward, this acts to lift the cross member 16 and all components of the apparatus mounted thereon and carried therewith. The mass of the weights 40 supported from the cross member 16 are selected so that the overall mass of the cross member and components carried therewith is low enough so that the drills being tested should be able lift this mass through operation of the air leg pneumatic controls in the expansion driving manner when the drill is in good operating condition, but sufficiently high so that a rock drill air leg not in such good operation condition, but rather being in need of service or repair would not lift the cross member and components carried therewith. Using a shackle at one or both of the connections between each cable and the cross member and respective weight allows easy removal and installation of weights on the apparatus to allow changing of the lift-resisting weight to enable testing of rock drills with different air leg specifications and capabilities.

In a drill test or torque test, the drill component is driven to drive rotation of the rod 20, which in turn drives operation of the hydraulic pump 18 via the driveshaft thereof. This draws hydraulic fluid from the reservoir through the pump, forcing it onward past the pressure gauge into the normally closed pressure relief valve. With this valve mechanism closed, the pumping of fluid from the pump against this closure of the conduit builds up the pressure within the portion of the conduit between the pump and the relief valve. Once this pressure buildup exceeds the threshold pressure value of the relief valve, the valve opens to allow the pressurized fluid to continue onward through the remainder of the conduit back to the reservoir 58. An operator of the test apparatus can confirm that the drill's torque is driving the pump sufficiently to reach this threshold pressure value in the closed section of the conduit by monitoring the pressure gauge. As shown in FIG. 2, the pressure gauge can be obliquely angled downward for easy viewing by the user from below. If no pressure buildup and subsequent relief is occurring, then the drill is not sufficiently driving the pump. Like with the mass selected to resist the lifting action on the test stand by the air leg, the threshold or actuating value of the relief valve is selected on the basis that driving of the pump with a properly operating drill will be capable of exceeding the this pressure value in the conduit, but a drill in need of repair would not reach the threshold pressure value. Use of an adjustable pressure relief valve allows this value to be changed to accommodate testing of rock drills with different drill specifications and rotational capabilities.

The testing apparatus can be calibrated once by determining the load lifting and rotational capabilities of a particular type of drill, or of different drills having similar capabilities or ratings, and then used repeatedly to test multiple drills of the same type or ability. The individual tests require no taking of measurements and no comparison of performance values against the known performance characteristics of a properly functioning drill of the same type. The operator of the test stand merely needs to visually confirm the lifting of the cross member and visually confirm the fluctuating pressure in the fluid passage under the opening and subsequent re-closing of the relief valve. Failure of the rock drill to upwardly displace the cross member in the leg test indicates repair of the air leg component of the rock drill is likely required, and accordingly the rock drill should not be dispensed for use in a mine. In the same manner, failure of the rock drill to build up sufficient pressure to actuate the relief valve indicates repair of the drill component of the rock drill is likely required, and accordingly the rock drill should not be dispensed for use in a mine. Acknowledging failure of one or both of the tests prevents an unsuitable rock drill from being sent out for use on the job, and identifying which of the two tests failed provides further information on which of the two components requires repair. Not only is time not wasted on transporting the rock drill into a mine, only to realize it is not functional and have to transport it back out of the mine for repair, but also diagnostic and/or disassembly and reassembly time during repair is minimized since which one(s) of the component require repair has already been identified.

The present invention can therefore be employed at a mining site, for example at a shop or storage area outside the mine, to quickly and easily test each rock drill before its deployment into the mine to improve productivity by reducing otherwise wasted transport and repair downtime of a rock drill.

### Variations

The particular materials and part configurations described with reference to the illustrated embodiment reflect a prototype construction employed in development of the present invention, and will be appreciated that material types, structure of individual parts and configuration of the parts with one another may be varied without departing from the scope of the present invention. For example, while mild steel plates and bars and steel tubing were used in the prototype, other materials may be employed, for example to reduce the weight of the apparatus to increase portability, provided that the resulting parts are of suitable strength for the end use of the apparatus. Telescopic rail assemblies, as opposed to nesting of a tube or bar within a larger outer tube, may be employed for sliding lifting and lowering of the cross member. It also may be possible to replace the telescopically supported cross member with a displacable structure that slides or rolls along vertical rails projecting away from the base and has its fully retracted position nearest the base defined by stops in the rails at a distance above the base.

In a further alternate embodiment, the testing apparatus may be laid out horizontally instead of being configured as the vertically extending test stand of the illustrated embodiment. A fixed body structure defining a vertical base surface against which the air leg can push could have a horizontally displaceable structure spaced therefrom, the rock drill being being placeable between the structures to bear against the fixed structure and displace the movable structure away therefrom under expansion of the leg. Telescopic or rail supports could again guide or limit the motion of the displaceable structure to occur in a linear manner. However, the vertical stand construction has the benefit that the weight of the displaceable structure and components carried therewith acts to automatically return it to the retracted position, and also benefits from a smaller footprint (i.e. less occupied surface area/floor space). It will also be appreciated that the pump used to test the torque or rotational performance of the rock drill, and the associated components cooperating the pump, may alternatively be mounted on the stationary base, as opposed to the displaceable structure movable relative thereto.

The suspended weights of the illustrated embodiment improve safety by keeping a significant portion of the lift-resisting weight lower than if carried directly on the cross member, making the apparatus less top-heavy, and the weight guides prevent the weights from swinging or swaying and potentially injuring the operator or other personnel. However, other test systems or methods in which weights are not suspended below the cross member, including horizontally oriented test apparatuses mentioned above, could still make use of the easy to evaluate torque test using the pumping and pressurization of a fluid as the performance marker. Similarly, vertically oriented stands using the suspended weights may benefit from their advantages without necessarily using a fluid-based torque test if some other source of rotational resistance is instead employed to allow visual confirmation of a rock drill's rotational performance when the rotational resistance is overcome. In the illustrated embodiment, the lifting resistance is adjustable by adding to or reducing the weight carried by the cross member and attached movable sections of the support legs and the rotational resistance is adjustable by changing the threshold pressure value of the relief valve benefits from flexibility and adaptability, but test systems intended for use with only one particular rock drill type may be constructed to have fixed resistances based on the known performance characteristics of a properly functioning drill of that type.

While the illustrated embodiment uses a pressure gauge to reflect whether the rotational drive of the drill is in good operating condition based on the pressure in the fluid passage, it may be possible to use other indicators. For example, it may be possible to configure the relief valve to perform some function upon reaching the threshold pressure that provides an indication of a successful torque test to the operator. While this could trigger an audible signal, preferably a visual signal or indicator is used due to high noise levels associated with the operation of a rock drill.

It will also be appreciated that the fluid being pressurized through the rotation of the rock drill need not necessarily be a hydraulic fluid or even a liquid, as an alternative embodiment could alternatively pressurize and subsequently release a gas or combination of gases. For example, one embodiment could use coupling of the rock drill chuck to the driveshaft of an air compressor discharging into a closed conduit or vessel until the pressure buildup exceeds the actuating value of a pressure relief valve installed thereon. The air compressor could draw on ambient air from the environment in which the apparatus is installed and bleed the pressurized air off back into the environment through a suitable discharge after the pressure relief valve is opened.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A rock drill testing apparatus comprising:
a base structure;
a displaceable structure spaced from the base structure and movable toward and away from the base structure along a linear axis;
a fluid pumping mechanism mounted to a respective one of the base and displaceable structures, the fluid pumping mechanism thereof being operable by driven rotation of an input shaft thereof extending parallel to the linear axis, the input shaft being rotatable about the linear axis relative to the base and displaceable structures and being engagable with a drill component of a rock drill at an end of the input shaft nearest an opposite one of the base and displacement structures;
a fluid passage communicating with an outlet of the pumping mechanism;
a flow control mechanism operably installed on the fluid passage at a distance therealong from the outlet of the fluid pumping mechanism to close and then open the fluid passage with the fluid pumping mechanism running to first cause a buildup of pressure in the fluid passage when closed and then relieve the buildup of pressure in the fluid passage when opened; and
an indicator mechanism associated with the fluid passage and operable to provide an indication of a status of the buildup of pressure in the flow passage under operation of the fluid pumping mechanism with the fluid passage closed.

2. The apparatus of claim I wherein the fluid pumping mechanism comprises a hydraulic pump and the fluid passage is also communicating with an inlet of the fluid pumping mechanism.

3. The apparatus of claim 2 wherein the fluid passage comprises a a fluid conduit that communicates with the inlet and outlet of the fluid pumping mechanism and a hydraulic fluid reservoir connected inline with the fluid conduit at a position therealong between the flow control mechanism and the inlet of the fluid pumping mechanism.

4. The apparatus of claim 3 wherein the hydraulic fluid reservoir is mounted on the respective one of the base and displaceable structures on which the hydraulic pump is mounted.

5. The apparatus of claim 1 wherein the flow control mechanism comprises a pressure relief valve installed on the fluid passage to open the fluid passage only after the pressure buildup therein exceeds a given level.

6. The apparatus of claim 1 wherein the displaceable structure disposed over the base structure and is movable upward and downward away from and toward the base structure.

7. The apparatus of claim 1 comprising displacement resisting devices associated with the displaceable structure to resist movement thereof away from the base structure.

8. The apparatus of claim 7 wherein the displaceable structure disposed over the base structure and is movable upward and downward away from and toward the base structure, and the displacement resisting devices comprises weights carried with the displaceable structure and suspended at a position downward therefrom.

9. The apparatus of claim 8 wherein the weights have guide features thereon cooperable with stationary guide members projecting away from the base structure toward the displaceable structure to guide motion of the weights along the guide members during lifting and lowering of the displaceable structure away from and toward the base structure.

10. The apparatus of claim 9 wherein the guide features comprise collars fixed to the weights and closing around the guide members.

11. The apparatus according to claim 9 comprising stops defined on the guide members for engagement thereagainst by the guide features on the weights under lifting of the displaceable structure away from the base structure by a given distance to prevent movement of the guide features passed upper ends of the guide members.

12. The apparatus of claim 8 wherein the weights comprise metal plates.

13. The apparatus of claim 9 wherein the guide members comprise outer tubular members fixed to the base structure and projecting upward therefrom parallel to the linear axis and inner members fixed to and projecting downward from the displaceable structure are slidably received in the guide members to limit movement of the displaceable structure to movement along the linear axis.

14. The apparatus of claim 1 wherein the indicator mechanism comprises a pressure gauge operably installed on the fluid passage between the outlet of the fluid pumping mechanism and the flow control mechanism.

15. The apparatus of claim 1 wherein the fluid pumping mechanism is carried on the displaceable structure on a side thereof opposite the base structure and the input shaft projects through the displaceable structure.

16. The apparatus of claim 1 wherein movement of the displaceable structure is guided by a pair of parallel telescopic supports projecting from the base structure to the movable structure, the telescopic supports comprising stationary sections fixed to the base structure adjacent opposite sides thereof and movable sections slidable relative to the stationary sections toward and away from the base structure, and the displaceable structure comprising a cross member fixed to and extending between the movable sections of the parallel telescopic supports for movement with the movable sections toward and away from the base structure.

17. The apparatus of claim 16 wherein the stationary sections of the telescopic supports comprise tubular members in which the movable sections of the telescopic supports are slidably disposed.

18. The apparatus of claim 1 wherein the pumping mechanism is mounted to the displaceable structure.

19. A rock drill testing apparatus comprising:
a base structure;
a displaceable structure positioned over the base structure at a distance upward therefrom and lowerable and liftable toward and away from the base structure along a linear axis;
a rotatable element mounted to a respective one of the base and displaceable structures and extending parallel to the linear axis, the rotatable element being rotatable about the linear axis relative to the base and displaceable structures against a source of rotation resistance and being engagable with a drill component of a rock drill at an end of the rotatable element nearest an opposite one of the base and displacement structures; and
weights carried with the displaceable structure and suspended at positions downward therefrom to resist lifting of the displaceable structure away from the base structure.

20. A rock drill testing method comprising:
positioning a rock drill between a base surface and a displaceable load movable toward and away from the base surface;
with the rock drill remaining between the base surface and the displaceable load, performing a leg test and a drill test, the leg test comprising attempting to extend a telescopic leg component of the rock drill against the load to move the load away from the base surface and the drill test comprising using a drill component of the rock drill as a drive source for a fluid pumping mechanism to attempt to pump fluid into a closed fluid passage and buildup a pressure level therein; and
deeming the rock drill either (a) suitable for use if the rock drill passes both the leg test and the drill test by successfully moving the load away from the base surface in the leg test and successfully building up the pressure level in the drill test, or (b) unsuitable for use if the rock drill fails one or both of the leg test and the drill test.
